(19) United States
(12) Patent Application Publication
(10) Pub. No.: US 2022/0227580 A1
(43) Pub. Date: Jul. 21, 2022

(54) AUTOMATED PACKAGE DELIVERY DEVICES, MACHINES, AND SYSTEMS

(71) Applicant: Thanh Dang Nguyen, Chicago, IL (US)

(72) Inventors: Thanh Dang Nguyen, Chicago, IL (US); Hung Van Hoang, Hue City (VN); Ngoc Duy Nguyen, Geelong (AU); Phung Thi My Huynh, Chicago, IL (US); Tien Thi My Huynh, Ho Chi Minh City (VN); Thach Ba Nguyen, Sakatoon (CA)

(21) Appl. No.: 17/150,436

(22) Filed: Jan. 15, 2021

(51) Int. Cl. B65G 1/133; G05B 19/4155; B65G 1/137; B65G 1/04

(52) U.S. Cl. CPC B65G 1/133; G05B 19/4155; G06Q 10/0836; B65G 1/0485; B65G 1/137

(57) ABSTRACT

An automated package delivery machine, comprising: a housing with auto-lock doors; carousels; and robotic assemblies. The housing may substantially enclose the carousels and the robotic assemblies, and substantially prevents unwanted access to an interior of the housing. Each carousel may comprise a plurality of storage containers, a drive belt, a motor, and one or more rails. The storage containers may each have a plurality of slots, which are configured to accept and contain one or more packages to be delivered to one or more customers. The rails may form a loop track to which the storage containers are slidably engaged. The drive belt, driven by said motor, is configured to slidingly move the storage containers along the rails. The robotic assemblies are configured to remove the packages from the slots and deliver them to an interior side of the auto-lock doors.

### FIELD OF USE

The present disclosure relates generally to automated equipment, and more particularly to automated package delivery devices, machines, and systems that is centrally located, accepts incoming packages and then automatically delivers them to customers who travel to pick up their specific package.

### BACKGROUND

Last mile is a term used in transportation planning and supply chain management to describe the movement of goods from one or more hubs/warehouses to a final delivery destination. In supply chain management and delivery logistics, the “last mile” describes the difficulty in transporting packages from the hubs to the consumer that ordered the goods. Since the explosion of online ordering and the rise of massive online retail stores, last mile delivery is an increasingly studied field as the number of business to consumer (b2c) deliveries grow. Some of the challenges of last mile delivery include minimizing cost, ensuring transparency, increasing efficiency, and improving infrastructure.

One last mile solution is to deliver all of the packages destined for one specific geographic area to a central hub and then allow the customers to come and pick up the packages. This model is similar to the Post Office Box model. Currently, there are numerous types of pick-up hubs that attempt to overcome the last mile problem. These include mostly manual facilities and somewhat automated kiosks. The current semi-automated kiosks have significant limitations, such as being too small, and thus containing a very limited number of packages, and being only partially automated. Another limitation with the kiosk package locker models in use before the present disclosure is that each locker can only contain one customer's package(s). Thus, the capacity is limited to the number of lockers that are in each semi-automated kiosk. Currently, this means that only about 50 customers can be serviced at a time in a semi-automated kiosk.

Thus, what is needed is a fully automated package delivery device and system wherein the has a significant increase in capacity and wherein each storage cabinet may contain packages related to several different customers

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to automated package delivery machines, kiosks, hubs, devices, and systems.

The package delivery hub, device, and system may comprise a housing that is located in an easily accessible space, public or private, wherein the company or companies delivering packages have access to loading packages into the machine, but customer's and members of the public have no access other than to receive their package that is automatically delivered to them by the machine.

The automated package delivery machine may comprise a housing, one or more carousels, one or more robotic assemblies, one or more roller ramps, and one or more auto-lock doors. The carousels may be side by side or stacked. The carousels may comprise rails, which may be configured as a loop. The carousels may also comprise a plurality of storage containers that slidingly engage with the rails, such that they may be moved from loading positions, to unloading positions, and to storage positions. The storage containers may be moved by an encircling belt that is driven by a motor, gear, and belt assembly. The robotic assemblies are configured and programmed to move the packages within the storage containers to the roller ramps, which funnel the packages to the auto-lock doors, which are opened only for the appropriate customer.

The automated machine and system of the present disclosure may have a housing that is strong and substantially prevents unwanted access.

The carousels may be positioned to be horizontal, vertical, or any diagonal in-between, depending on the shape of the housing and regardless of whether the automated machine and system is inside or outside of another structure.

The automated machine and system of the present disclosure may be mobile, or it may be substantially stationary. The automated package delivery system may be located in a publicly accessible location that does not require the user to access private property to reach.

The automated machine and system of the present disclosure may allow access to one, two, or more transportation/delivery companies. If for one company, the machine may act as a centralized shipping location to which numerous customers of the single company in a single area may select to have their packages shipped. If for two or more companies, the machine may act as a quasi-public shipping location to which numerous customers of all of the participating companies may select to have their packages shipped. In this manner, the small companies agreeing to use the automated package delivery machine as a shipping location may be on equal footing with large box stores that can offer reduced cost shipping and/or pick up at a store that is close to any particular customer.

One embodiment may be an automated an automated package delivery machine, comprising: a housing with one or more auto-lock doors; one or more carousels; and one or more robotic assemblies; wherein said housing substantially encloses said one or more carousels and said one or more robotic assemblies, and substantially prevents unwanted access to an interior of said housing; wherein each of said one or more carousels comprises a plurality of storage containers, a drive belt, a motor, and one or more rails; wherein each of said plurality of storage containers comprises a plurality of slots; wherein each of the plurality of slots are configured to accept and contain one or more packages to be delivered to one or more customers; wherein the one or more rails form a loop track to which the plurality of storage containers are slidably engaged; wherein the drive belt, driven by the motor, is configured to slidingly move the plurality of storage containers along the one or more rails; and wherein the one or more robotic assemblies are configured to remove the one or more packages from the plurality of slots and deliver the one or more packages to an interior side of the one or more auto-lock doors. The automated package delivery machine may further comprise a central access display that is configured to be engaged with by the one or more customers to have the one or more packages from the automated package delivery machine delivered to the one or more users. The housing is configured to provide access to one or more deliver persons to load the one or more packages into the plurality of storage containers. The one or more auto-lock doors may be configured to unlock automatically so the one or more customers may retrieve the one or more packages from the automated package delivery machine. In other embodiments, the auto-lock door may be opened automatically, not just unlocked automatically. The automated package delivery machine may be substantially a permanent installation or substantially a mobile installation. Preferably, the automated package delivery machine may be in a publicly accessible location. The automated package delivery machine may further comprise one or more roller ramps that may be located, respectively, between the one or more robotic assemblies and the one or more auto-lock doors, such that the one or more robotic assemblies may deliver the one or more packages to the one or more roller ramps, which slidingly move the one or more packages to the interior side of the one or more auto-lock doors. the plurality of slots in each of the plurality of storage containers may be formed by a slot grid. The slot grid may be adjustable so that one or more larger packages may be loaded into the one or more storage container.

The robotic assemblies may be configured to either pull (as shown in the Figures) or push the package items out of the containers/slots.

In one embodiment, there are no roller ramps. Instead, a simple low friction slide/ramp may be used. Alternatively, the robotic assemblies may stay well on the inside of the auto-pickup machine and the carousel may move the containers to the position of the robotic assemblies to open a small door that corresponds to the slot, then move the container with the open slot to the auto-lock door so that user can physically remove the item/s in the slots. In this embodiment, the slide or roller ramps are not included.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow block diagram showing a method of using the device and system of the present disclosure.

FIG. 2 is an illustration of one embodiment of the automated package delivery machine of the present disclosure.

FIG. 3 is an illustration of one embodiment of a storage container that is part of the automated package delivery machine.

FIG. 4 is an illustration of another embodiment of the automated package delivery machine of the present disclosure.

FIG. 5 is an illustration of one embodiment of the automated package delivery system.

FIG. 6 is an illustration of another embodiment of the automated package delivery system.

FIG. 7 is an illustration of one portion of one embodiment of the automated package delivery system.

FIG. 8 is an illustration of another portion of one embodiment of the automated package delivery system.

### DETAILED DESCRIPTION OF ILLUSTRATIVE EMBODIMENTS

In the following detailed description of various embodiments, numerous specific details are set forth in order to provide a thorough understanding of various aspects of one or more embodiments. However, the one or more embodiments may be practiced without some or all of these specific details. In other instances, well-known methods, procedures, and/or components have not been described in detail so as not to unnecessarily obscure aspects of embodiments.

While multiple embodiments are disclosed, still other embodiments of the present disclosure will become apparent to those skilled in the art from the following detailed description, which shows and describes illustrative embodiments. As will be realized, the embodiments are capable of modifications in various obvious aspects, all without departing from the spirit and scope of the present disclosure. Accordingly, the graphs, figures, and the detailed descriptions thereof, are to be regarded as illustrative in nature and not restrictive. Also, the reference or non-reference to a particular embodiment shall not be interpreted to limit the scope.

Before the embodiments are disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where the event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

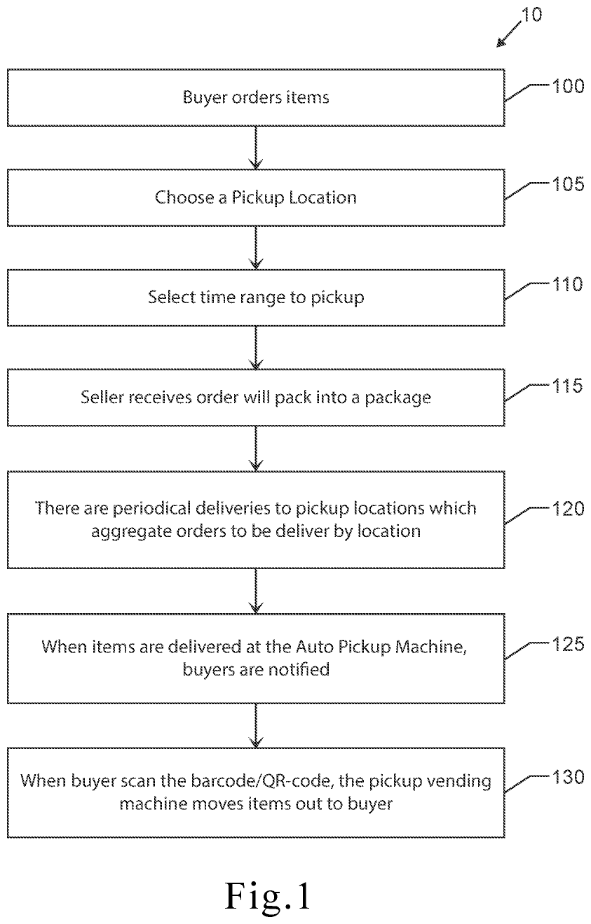

FIG. 1 is a flow block diagram showing a method of using the device and system of the present disclosure. FIG. 1 shows that the method 10 may comprise the steps of a customer or buyer ordering one or more products 100, typically via an online purchase. As part of the order, the user selects to have the product delivered to an automated package delivery machine location 105. The user may select this option because the shipping charges would be substantially less than having the products shipped directly to the customer's home or business. Optionally, the user may select a specific day, time, and or range to have the package be available for retrieval 110. The seller may then process the order and prepare for it to be shipped to the automated package delivery machine location 115. To save even more in shipping, the company or shipping company may consolidate orders to be picked up periodically for specific locations of the automated package delivery machine location 120. After the customer's products are delivered to the automated package delivery machine location, the customer is notified 125, typically via email, text, or phone. The buyer then travels to the automated package delivery machine location, interacts with the machine, and has the package(s) delivered automatically 130. The user typically scans a QR code or punches in a code or password at an interface on the outside of the machine. This confirms to the machine which package is to be delivered to the customer. Preferably, the package is delivered to the customer automatically. The package is taken out of the storage container, which may or may not contain additional packages, selected by an automated mechanism, such as a robotic arm and then moved to an external portal of the machine.

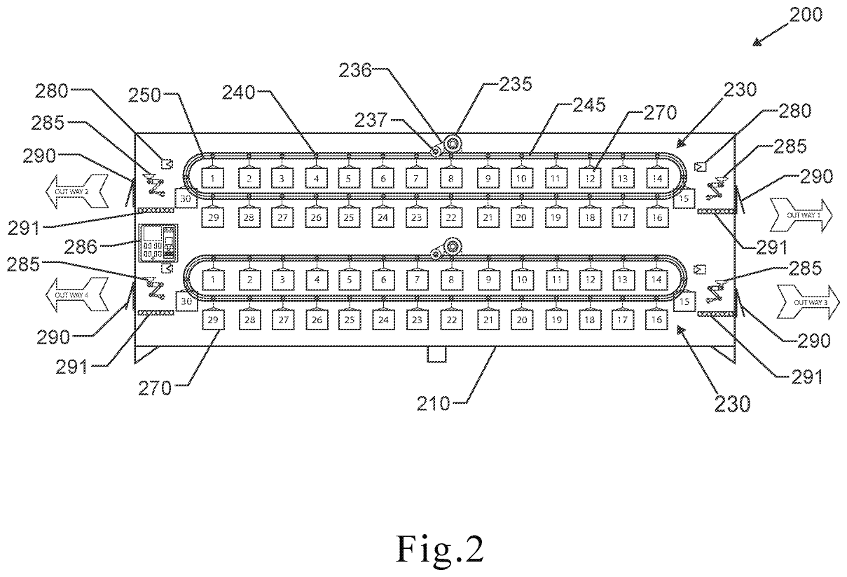

FIG. 2 is an illustration of one embodiment of the automated package delivery machine of the present disclosure. As shown in FIG. 2, the automated package delivery machine 200 may be a permanent, quasi permanent, or moveable package storage hub that is configured to contain packages whose final destination is within the nearby area. The automated package delivery machine 200 may comprise a cover or housing 210, which may have one or more doors or package input locations that allow one or more delivery companies or persons to access the automated package delivery machine 200 and place incoming packages into the storage containers or goods crates 270. In some embodiments, the cover 210 may be large enough to allow the delivery person to enter into the housing in order to load in packages to be delivered. Preferably, the delivery person manually or wirelessly engages with the automated package delivery machine 200 so that the automated package delivery machine 200 knows in which storage container the package was loaded.

The customers may engage with a central access system or display 286 that may be part of or attached to the cover 210. Typically, the user may have a QR or barcode on paper or mobile device that is scanned by the central access display 286. Alternatively, the user may punch in a code, tap, insert a chipped card, swipe a card, or use a near field wireless communication (and the like) to alert the machine 200 that a customer is next to the machine and is ready to retrieve a package. After scanning, swiping, tapping, inserting, touching, punching in, touchlessly communicating, and/or linking, the automated package delivery machine 200 automatically moves the storage container 270 that contains that customer's package(s) so that the customer's package(s) can be automatically delivered to the customer. The cover 210 may also house the auto-locked doors 290, which are locked unless providing access to a customer who then immediately removes a delivered package.

The central access display 286 may also comprise or may be connected to a local electronic data processing unit that is configured to provide local data processing to the machine 200. Preferably, the machine 200 is wirelessly connected, and/or has a wired connection, to a control server/cloud, which provides secure control and programming to the machine 200. In some embodiments, the control server/cloud acts as a controller for numerous machines 200. The control server/cloud and/or local data processing unit may provide the programming necessary to allow the delivery persons to appropriately load the packages into the storage containers 270, such that the machine 200 is able to automatically move the storage container to an unload location next to one of the robotic assemblies 285. The control server/cloud and/or local data processing unit may provide the programming necessary to allow the robotic assemblies 285 to move any specific package from the storage container to the appropriate auto-lock door 290. The auto pickup machine may be controlled by a simple embedded system programmed with PLC (Programmable Logic Controller) with a network interface card (NIC) or a wireless communication driver.

Within the housing, the automated package delivery machine 200 may comprise, one, two, or more carousels 230, which may comprise a plurality of storage containers 270, side rails 250, chain or belt 245, bearings 240, motor 235, timing belt or chain 236, and gear or pulley 237. Although other mechanisms can be used the carousels 230 provide a preferred, compact, and reliable way to store the packages while they away final delivery and an efficient way to move the packages into position for final delivery. As shown in FIG. 2, the storage containers 270 may be moveably engaged with the rails 250 and the bearings 240, such that they are pulled along the oblong path of the rails 250 by the belt 245. The belt is driven by the motor gear 237, which itself is driven by motor 235 and timing belt 236. Other powered mechanisms may be used so long as the storage containers 270 are moved along the rails 250. The motor 235 may be any kind of motor including gas, electric, brushless, and the like. Carousels 230 are configured to move any particular storage container 270 near one of the four or more robotic assemblies 285, which are configured to unload the packages from the storage containers 270 and deliver the packages next to the auto-locked doors 290. In one embodiment, the robotic assemblies 285 may be articulating robotic arms or a grid/slider based robotic system. In one embodiment, the robotic assemblies 285 may place the being delivered packages on a roller ramp 291 or a conveyor belt, which may slide or move the packages to being just inside the auto-locked doors 290. The packages may be removed from the storage container 270 by the robotic assembly 285 in several different ways, including, but not limited to: pushing/piston, vacuum, suction, and/or a claw. In one embodiment the package may be scanned at barcode 280 to ensure that the package picked up by the robotic assembly 285 is the correct one. This final scan may be a way for the system to confirm delivery of the correct package to the correct customer.

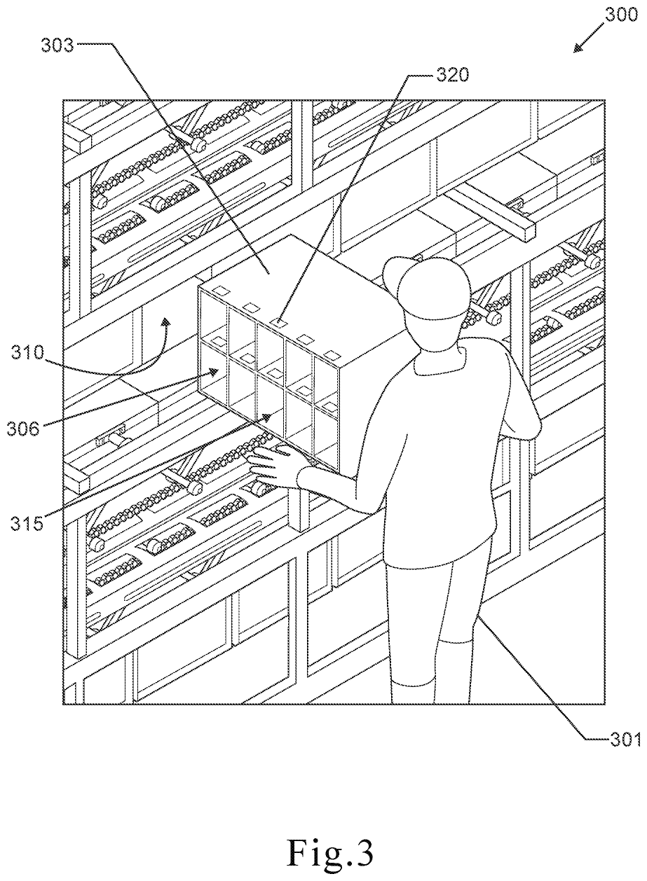

FIG. 3 is an illustration of one embodiment of a storage container that is part of the automated package delivery machine. FIG. 3 shows that automated package delivery machine 300 may be loaded with packages by a delivery person 301. The packages may be loaded into one or more storage containers 305, which may have one or more package slots 306. The storage containers 305 may be removed, fully, or partially, from storage container slots or frames 310, which allows one or more packages to be loaded into the one or more package slots 306. In one embodiment, the storage containers may be flexible regarding how many packages may be loaded. Specifically, if the package to be delivered is very large, the package may take up multiple package slots. This may be done by having the package slot grid 315 (which forms the package slots 306) be moveable, adjustable, collapsible, or entirely removeable. Preferably, the delivery person 301 may identify what package is going into what slot 306 of what storage container 305. This may be done in many ways, which includes scanning the slot identifier 320 when the package is loaded. The automated package delivery machine 300 knows in which slot 306 each package is loaded. This allows the automated package delivery machine 200 to move the correct container 305 into the correct position to allow one of the robotic assemblies to engage with the correct package and deliver it to the correct customer.

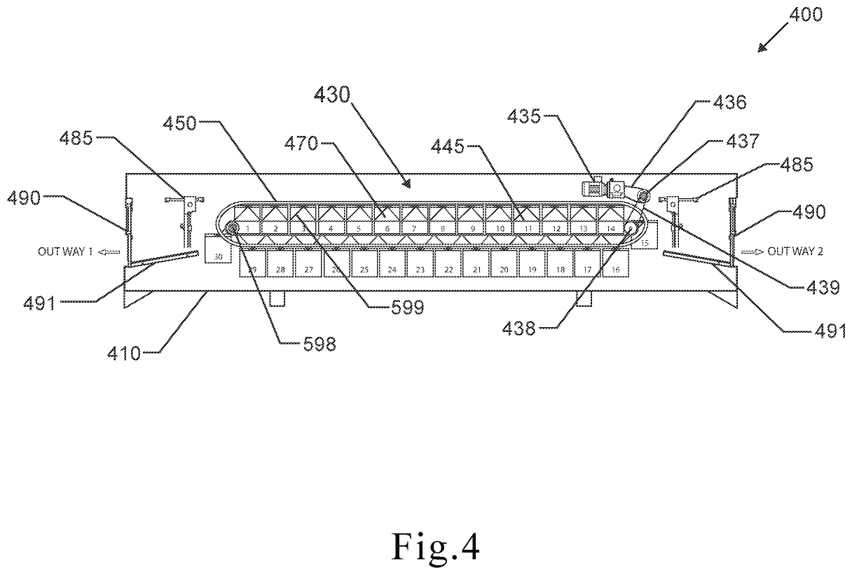

FIG. 4 is an illustration of another embodiment of the automated package delivery machine of the present disclosure. As shown in FIG. 4, one embodiment of the automated package delivery machine 400 may comprise a single carousel 430 within housing 410. As shown the housing may have two auto-lock access doors 490, which allows customers to retrieve packages. The auto-lock doors 490 may be at the end of roller ramps 491, which allows the packages to slide down and be just on the inside of the auto-lock doors, ready for retrieval by the customer. The robotic assemblies 485 are configured to remove packages from the storage containers 470 and deliver them to the customers. As shown in FIG. 4, the robotic assemblies may be a sliding arm grid robotic device that aligns a picking arm with the package to be delivered. In other embodiments there may be a piston that pushes the package out of the container slot. The picking arm engages the package and then the sliding arm grid robotic device places it at the start of the roller ramp 491, which then uses gravity to funnel/roll the package down to the auto-lock access door 491. In other embodiments, the robotic assembly may be an articulating arm, crane, drone, suspended wire rig, or any other type of robotic mechanism that can transport the package to be delivered to the customer. In one embodiment, the picking arm has a suction or vacuum device that allows the picking arm to securely grasp the package and move it into position for final delivery. In another embodiment, the picking arm may use refreshable adhesives to engage the packages. In another embodiment, the picking arm may us a claw or clamp to physically grasp the package.

Carousel 430 is configured to move the storage containers into a position for engagement by the robotic assemblies 485. As shown in FIG. 4, the carousel 430 may comprise a set of rails 450, which may form an oblong looped track, along which the storage containers 470 may slide. Typically, the storage containers 470 may engage the rails 450 via a wheeled or bearing engagement mechanism. The storage containers 470 may be moved slidingly along the rails 450 by a drive belt or chain 445, which runs along the horizontal length of the machine 400 between the end gear 598 and the belt drive gear 438. The drive belt 445 may be an articulating link chain that is connected to drive belt connectors 599, which may also engage with each of the storage containers 470. In this manner, as the drive belt 445 moves, the storage containers slidingly move as well along the rails 450 in an oblong loop. The drive belt 445 may also be a notched rubber or plastic drive belt. The drive belt 445 may be connected to a belt drive gear 438, which may be connected to a pulley belt 439, which may be connected to timing gear 437, which may be connected to timing belt 436, which may be connected to high powered motor 435. The motor 435 may be controlled by the automated package delivery machine 400 such that it starts and stops in order to move the storage containers 470 into a position to automatically load and deliver/unload packages. The system of gears 438, 437, 598 and belts 436, 439 are configured to allow the appropriate torque to be provided to the drive belt 445 in order to smoothly and automatically move the storage containers 470 along the rails 450.

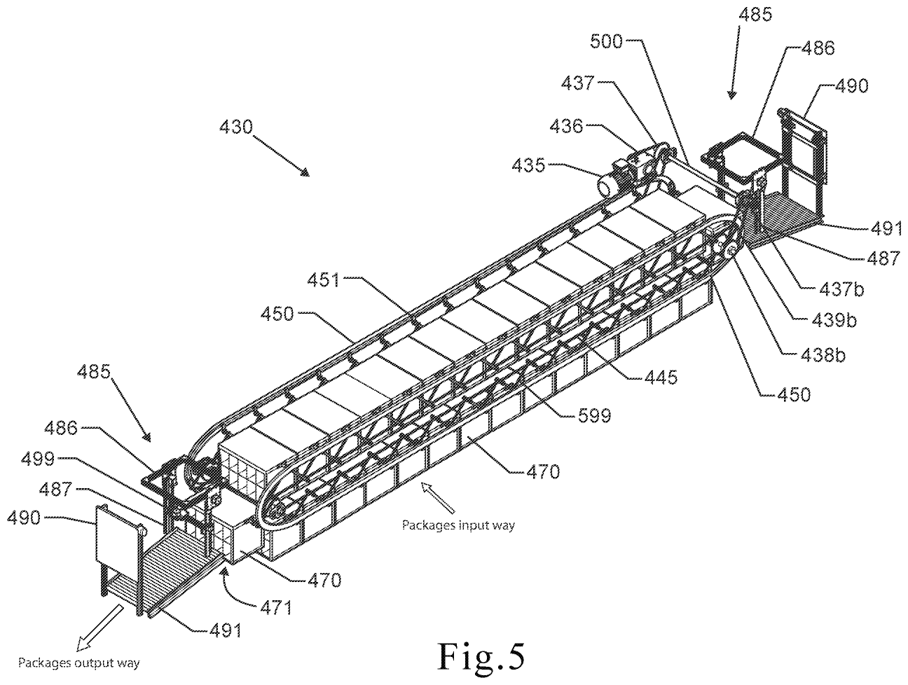

FIG. 5 is an illustration of one embodiment of the automated package delivery system. FIG. 5 shows that the carousels 430 may comprise two rails 450 from which storage containers 470 may be suspended. FIG. 5 shows that the storage containers 470 may comprise a plurality of slots 471 and rail/container connectors 451, which is how the containers 470 may slidingly connect to the rails 450. FIG. 5 also shows that the carousel drive system may comprise a drive shaft 500, which may interconnect the main gears 438, 437 and belts 436, 439 with a reciprocal set of gears 438b, 437b and pulley belt 439b.

Preferably, there are two drive belts 445, one on each side of the carousel 430. These drive belts 445 are both powered by the motor 435, such that the storage containers 470 are pulled smoothly along the rails 450.

FIG. 5 shows that the storage containers 470 may be accessed when they are on the bottom portion of the rail loop of the carousel 430.

FIG. 5 shows one embodiment of the robotic assemblies 485 that may be used to move the packages from the storage containers 470 to the roller ramp 491. Once the package slides down the roller ramp 491, the auto-lock door 490 may open, as shown, so that the customer may retrieve the automatically delivered package. As shown, the robotic assemblies 485 may be grid/slider based robotic assembly that may comprise a horizontal portion 486, a vertical portion 487, and a picker arm 499. Once the vertical portion 487 and horizontal portion 486 position the picker arm 499 in front of the correct slot 471, the picker arm 499, via its programming, automatically engages with the package in the correct slot 471 and moves the package to the inside of door 490.

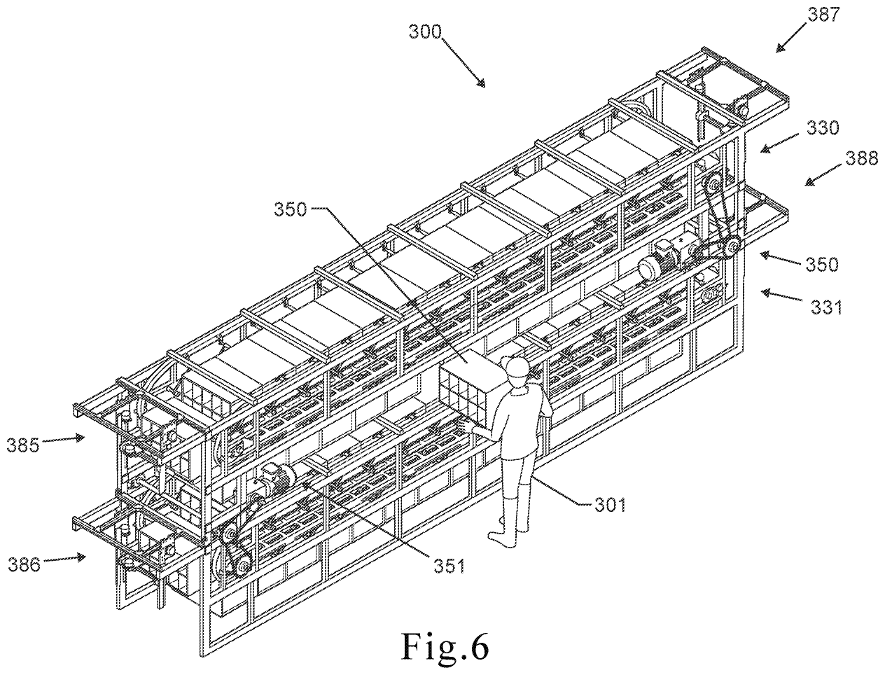

FIG. 6 is an illustration of another embodiment of the automated package delivery system. As shown in FIG. 6, the automated package delivery machine 300 may be loaded with packages by a delivery person 301. The automated package delivery machine 300 may comprise two stacked carousels 330, 331, which each have a motor, gear, belt assembly 350, 351, which move the storage containers around the looped rails of the carousels. Each carousel 330, 331 may have a robotic assembly 385, 386, 387, 388, on each end to remove the packages from the storage containers 305 and output them to a customer.

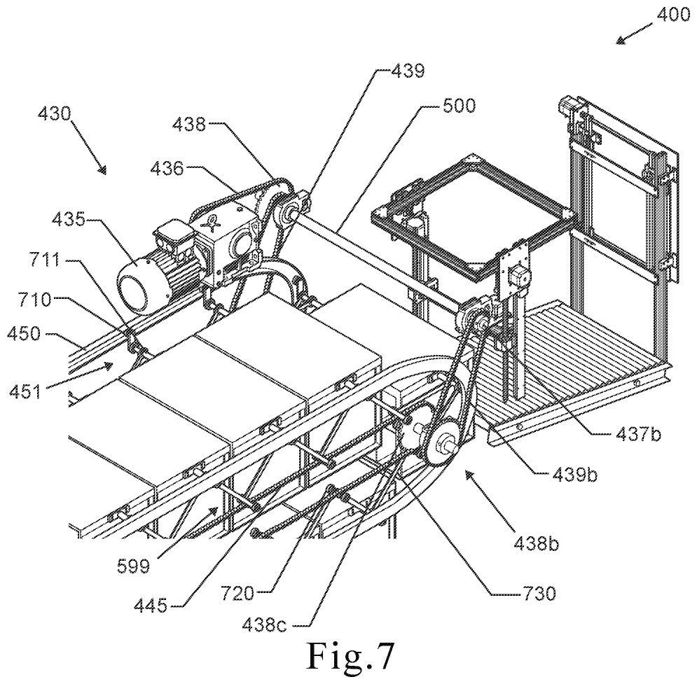

FIG. 7 is an illustration of one portion of one embodiment of the automated package delivery system. As shown in FIG. 7, the carousel 430 may comprise two rails 450 from which storage containers 470 may be engaged and/or suspended. As shown, each of the two rails 450 may be a C-bar, which forms a continuous loop track that partially encloses a plurality of bearing wheels 710, each of which are connected to a rail/container connector 451. As shown, each rail/container connector may comprise a container bar 711, two of which extend horizontally outward from the two sides of each container 470 and connect the storage containers 470 to both the rails 450 and the drive belts 445.

FIG. 7 also shows how the drive belts 445 are powered by motor 435. Motor 435 is connected to timing belt 436, which is connected to and turns timing gear 437, which is connected to drive shaft 500 and pulley belt 439. Pulley belt 439 may then drive belt drive gear 438, which is connected to drive belt 445, which is connected to the rails 450 and, preferably, all of the storage containers 470. In this manner, when the motor 435 is on, the drive belt 445 is driven, forward or backward, such that the storage containers 470 slide, forward or backward, along the rails 450.

The drive shaft 500 is connected to drive belt gear 437b, which is connected to pulley belt 439b, which is connected to and drives belt drive gear 438b, which may comprise and/or be connected to interior belt drive gear 438c, which is the actual gear that engages with and turns one of the drive belts 445.

FIG. 7 shows that the drive belt connectors 599 is connected to the container bar 711 and rail/container connector 451, which mean that the drive belt connectors 599 are connected to the storage containers 470 and the rails 450. As shown, the drive belt connectors 599 are also connected to the drive belt 445 via a plurality of drive belt pins 720. In this manner, as the drive belts 445 rotate, the storage containers 470 also rotate along rails 450.

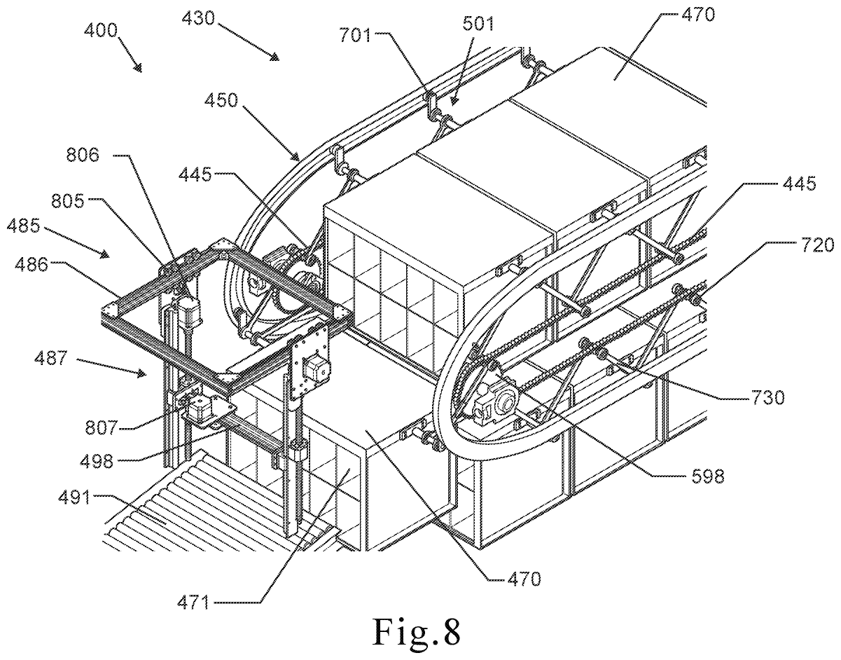

FIG. 8 is an illustration of another portion of one embodiment of the automated package delivery system. FIG. 8 shows that the drive belts 445 may also engage with end gears 598, which may be powered or unpowered.

FIG. 8 also shows that the robotic assembly 485 may comprise horizontal portion 486, vertical portion 487, horizontal picker bar 498, picker arm 499 (not shown in FIG. 8), x-axis actuator 805, y-axis actuator 806, and z-axis actuator 807. The horizontal portion 486 may comprise a frame to which vertical portion 487 hangs from. Vertical portion 487 may move back and forth along the frame of the horizontal portion 486 via the x-axis actuator. This allows the picker arm 499 to get closer to or further away from the slots 471 of the storage containers 470. The horizontal picker bar 498 may be moved up and down the vertical portion 487 via y-axis actuator 806. This allows the robotic assembly 485 to move the picker arm up and down along the height of the storage containers 470 to be placed in front of the correct slot 471 of the storage containers 470. The z-axis actuator 807 is preferably in close proximity to the picker arm 499 and both are configured to run back and forth along the horizontal picker bar 498. This allows the robotic assembly 485 to move the picker arm back and forth along the width of the of the storage containers 470 to be placed in front of the correct slot 471 of the storage containers 470. Once in place in front of the correct slot 471, the picker arm may automatically retrieve the package that is inside of the correct slot 471 and then drop it on the roller ramp 491.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An automated package delivery machine, comprising:
a housing with one or more auto-lock doors;
one or more carousels; and
one or more robotic assemblies;
wherein said housing substantially encloses said one or more carousels and said one or more robotic assemblies, and substantially prevents unwanted access to an interior of said housing;
wherein each of said one or more carousels comprises a plurality of storage containers, a drive belt, a motor, and one or more rails;
wherein each of said plurality of storage containers comprises a plurality of slots;
wherein each of said plurality of slots are configured to accept and contain one or more packages to be delivered to one or more customers;
wherein said one or more rails form a loop track to which said plurality of storage containers are slidably engaged;
wherein said drive belt, driven by said motor, is configured to slidingly move said plurality of storage containers along said one or more rails; and
wherein said one or more robotic assemblies are configured to remove said one or more packages from said plurality of slots and deliver said one or more packages to an interior side of said one or more auto-lock doors.

2. The automated package delivery machine of claim 1, further comprising a central access display that is configured to be engaged with by said one or more customers to have said one or more packages from said automated package delivery machine delivered to said one or more users.

3. The automated package delivery machine of claim 1, wherein said housing is configured to provide access to one or more deliver persons to load said one or more packages into said plurality of storage containers.

4. The automated package delivery machine of claim 1, wherein said one or more auto-lock doors are configured to unlock automatically so said one or more customers may retrieve said one or more packages from said automated package delivery machine.

5. The automated package delivery machine of claim 1, wherein said automated package delivery machine is substantially a permanent installation.

6. The automated package delivery machine of claim 1, wherein said automated package delivery machine is substantially a mobile installation.

7. The automated package delivery machine of claim 1, wherein said automated package delivery machine is in a publicly accessible location.

8. The automated package delivery machine of claim 1, further comprising one or more roller ramps that are located, respectively, between said one or more robotic assemblies and said one or more auto-lock doors, such that said one or more robotic assemblies deliver said one or more packages to said one or more roller ramps, which slidingly move said one or more packages to said interior side of said one or more auto-lock doors.

9. The automated package delivery machine of claim 1, wherein said plurality of slots in each of said plurality of storage containers are formed by a slot grid.

10. The automated package delivery machine of claim 9, wherein said slot grid is adjustable so that one or more larger packages may be loaded into said one or more storage container.

11. An automated package delivery machine, comprising:
a housing with one or more auto-lock doors;
one or more carousels;
one or more robotic assemblies; and
a central access display;
wherein said housing substantially encloses said one or more carousels and said one or more robotic assemblies, and substantially prevents unwanted access to an interior of said housing;
wherein each of said one or more carousels comprises a plurality of storage containers, a drive belt, a motor, and one or more rails;
wherein each of said plurality of storage containers comprises a plurality of slots;
wherein each of said plurality of slots are configured to accept and contain one or more packages to be delivered to one or more customers;
wherein said one or more rails form a loop track to which said plurality of storage containers are slidably engaged;
wherein said drive belt, driven by said motor, is configured to slidingly move said plurality of storage containers along said one or more rails;
wherein said one or more robotic assemblies are configured to remove said one or more packages from said plurality of slots and deliver said one or more packages to an interior side of said one or more auto-lock doors;
wherein said housing is configured to provide access to one or more deliver persons to load said one or more packages into said plurality of storage containers; and
wherein said central access display is configured to be engaged with by said one or more customers to have said one or more packages from said automated package delivery machine delivered to said one or more users.

12. The automated package delivery machine of claim 11, wherein said one or more auto-lock doors are configured to unlock automatically so said one or more customers may retrieve said one or more packages from said automated package delivery machine.

13. The automated package delivery machine of claim 11, wherein said automated package delivery machine is substantially a permanent installation.

14. The automated package delivery machine of claim 11, wherein said automated package delivery machine is substantially a mobile installation.

15. The automated package delivery machine of claim 11, wherein said automated package delivery machine is in a publicly accessible location.

16. The automated package delivery machine of claim 11, further comprising one or more roller ramps that are located, respectively, between said one or more robotic assemblies and said one or more auto-lock doors, such that said one or more robotic assemblies deliver said one or more packages to said one or more roller ramps, which slidingly move said one or more packages to said interior side of said one or more auto-lock doors.

17. The automated package delivery machine of claim 16, wherein said plurality of slots in each of said plurality of storage containers are formed by a slot grid.

18. The automated package delivery machine of claim 17, wherein said slot grid is adjustable so that one or more larger packages may be loaded into said one or more storage container.

19. An automated package delivery machine, comprising:
a housing with one or more auto-lock doors;
one or more carousels;
one or more robotic assemblies;
a central access display; and
one or more roller ramps;
wherein said housing substantially encloses said one or more carousels and said one or more robotic assemblies, and substantially prevents unwanted access to an interior of said housing;
wherein each of said one or more carousels comprises a plurality of storage containers, a drive belt, a motor, and one or more rails;
wherein each of said plurality of storage containers comprises a plurality of slots;
wherein each of said plurality of slots are configured to accept and contain one or more packages to be delivered to one or more customers;
wherein said one or more rails form a loop track to which said plurality of storage containers are slidably engaged;
wherein said drive belt, driven by said motor, is configured to slidingly move said plurality of storage containers along said one or more rails;
wherein said one or more roller ramps are located, respectively, between said one or more robotic assemblies and said one or more auto-lock doors, such that said one or more robotic assemblies deliver said one or more packages to said one or more roller ramps, which slidingly move said one or more packages to an interior side of said one or more auto-lock doors;
wherein said housing is configured to provide access to one or more deliver persons to load said one or more packages into said plurality of storage containers;
wherein said central access display is configured to be engaged with by said one or more customers to have said one or more packages from said automated package delivery machine delivered to said one or more users;
wherein said one or more auto-lock doors are configured to unlock automatically so said one or more customers may retrieve said one or more packages from said automated package delivery machine.

20. The automated package delivery machine of claim 19, wherein said plurality of slots in each of said plurality of storage containers are formed by a slot grid;
wherein said slot grid is adjustable so that one or more larger packages may be loaded into said one or more storage container.
